(19) United States
(12) Patent Application Publication
(10) Pub. No.: US 2013/0333144 A1
(43) Pub. Date: Dec. 19, 2013

(54) WIPER DEVICE

(71) Applicant: Helmut Depondt, Kessel-Lo (BE)

(72) Inventor: Helmut Depondt, Kessel-Lo (BE)

(73) Assignee: ROBERT BOSCH GMBH, Stuttgart (DE)

(21) Appl. No.: 13/994,112

(22) PCT Filed: Nov. 11, 2011
(86) PCT No.: PCT/EP2011/069902

§ 371 Date: Aug. 26, 2013

(30) Foreign Application Priority Data
Dec. 13, 2010 (DE) 102010062940.5

(51) Int. Cl. B60S 1/40

(52) U.S. Cl. CPC B60S 1/40
USPC 15/250.32

(57) ABSTRACT

The invention is based on a wiper device for a motor vehicle window, with a wiper arm adapter unit (10a-10o) and a wiper blade adapter unit (12a-12o) which, in a fitted state, form a form-fitting connection. It is proposed that the wiper device has at least one blocking means (14a-14o) which is mounted movably on the wiper blade adapter unit (12a-12o) for restricting the wiper arm adapter unit (10a, 10o) in the freedom of movement thereof, in the fitted state, in a direction deviating from a longitudinal direction (16a-16o).

### BACKGROUND OF THE INVENTION

The invention relates to a wiper device.

A wiper device for a motor vehicle window, having a wiper arm adapter unit and having a wiper blade adapter unit which form a positive fit in an assembled state, is already known.

### SUMMARY OF THE INVENTION

The invention is based on a wiper device for a motor vehicle window, having a wiper arm adapter unit and having a wiper blade adapter unit which form a positive fit in an assembled state.

It is proposed that the wiper device has at least one locking means which is mounted in a movable manner on the wiper blade adapter unit, said locking means being provided for restricting the wiper arm adapter unit in terms of its freedom of movement in a direction differing from a longitudinal direction in the assembled state. By means of a corresponding design, a coupling of the wiper blade adapter unit to the wiper arm adapter unit can be attained in a particularly reliable and comfortable manner. In this context, a “wiper blade adapter unit” should be understood to mean in particular an adapter unit which has a contact region to a wiper blade component and which is captively connected to the wiper blade component and which is intended for providing a coupling region of the wiper blade component for coupling to and/or contact with the wiper arm adapter unit. The wiper blade adapter unit preferably has a main body which provides a coupling surface for coupling to and/or contact with the wiper arm adapter unit. In this context, a “wiper arm adapter unit” should be understood to mean in particular an adapter unit which has a contact region to a wiper arm component and which is captively connected to the wiper arm component and which is intended for providing a coupling region of the wiper arm component for coupling to and/or contact with the wiper blade adapter unit. In this context, “intended” should be understood to mean in particular specially equipped and/or configured. In this context, an “assembled state” should be understood to mean in particular a state in which the wiper blade adapter unit and the wiper arm adapter unit are coupled to one another. In this context, a “longitudinal direction” should be understood to mean in particular a direction which extends at least substantially parallel to a main direction of extent of the wiper blade adapter unit. In this context, “substantially” should be understood to mean in particular a deviation of less than 10°.

If the locking means is mounted so as to be pivotable relative to a main body of the wiper blade adapter unit about a pivot axis, a coupling of the wiper blade adapter unit to the wiper arm adapter unit can be attained in a particularly simple manner.

If the pivot axis is arranged at least substantially parallel to a longitudinal direction of the wiper arm adapter unit, a coupling of the wiper blade adapter unit to the wiper arm adapter unit can be attained in a particularly reliable manner.

In a further embodiment, it is proposed that the pivot axis is arranged at least substantially parallel to a transverse direction of the wiper arm adapter unit, whereby a particularly simple construction of the wiper arm adapter unit can be attained. In this context, a “transverse direction” should be understood to mean in particular a direction which is perpendicular to the longitudinal direction and perpendicular to a vertical direction and which runs parallel to a wiper plane. In this context, a “wiper plane” should be understood to mean in particular an idealized plane which, during operation, is wiped by a wiper blade fastened to the wiper blade adapter unit. Here, in this context, a “vertical direction” should be understood to mean in particular a direction which is perpendicular to the wiper plane.

If the locking means is mounted so as to be linearly displaceable relative to a main body of the wiper blade adapter unit, the wiper arm adapter unit can be of particularly stable design. In this context, “linearly displaceable” should be understood in particular to mean a translatory movement.

If the wiper device has at least one securing means which is provided for preventing a movement of the locking means relative to a main body of the wiper blade adapter unit in at least one operating state, operational reliability of the wiper device can be advantageously increased.

In this context, a “securing means” should be understood to mean in particular a means which forms a non-positive and/or positive fit with a component of the wiper device.

It is also proposed that, in at least one operating state, the locking means forms at least a major part of a visible outer surface of the wiper blade adapter unit, whereby the wiper device can be advantageously protected against external influences such as, for example, water. In this context, a “major part” should be understood to mean in particular more than 50%, preferably 70%.

In a further embodiment of the invention, it is proposed that the locking means is in the form of a detent means. In this way, rapid coupling of the wiper blade adapter unit to the wiper arm adapter unit can be achieved. In this context, a “detent means” should be understood to mean in particular a means which undergoes an elastic deformation during an assembly sequence.

If the detent means is formed in one piece with a main body of the wiper arm adapter unit, the wiper blade adapter unit can be produced particularly inexpensively. “In one piece” should be understood to mean in particular cohesively connected, such as for example by means of a welding process and/or adhesive bonding process etc., and particularly advantageously integrally formed, such as by means of production by casting and/or by means of production in a single-component or multi-component injection molding process.

### BRIEF DESCRIPTION OF THE DRAWINGS

Further advantages will emerge from the following description of the drawing. The drawing illustrates exemplary embodiments of the invention. The drawings, the description and claims contain numerous features in combination. A person skilled in the art will expediently also consider the features individually and combine them to form further meaningful combinations. In the drawing:

FIGS. 1a to 1c show a perspective view of a wiper device in an assembly sequence,

FIGS. 2a to 2c show a perspective view of a further exemplary embodiment of a wiper device in an assembly sequence,

FIGS. 3a to 3c show a perspective view of a further exemplary embodiment of a wiper device in an assembly sequence,

FIGS. 4a to 4c show a perspective view of a further exemplary embodiment of a wiper device in an assembly sequence,

FIGS. 5a and 5b show a perspective view of a further exemplary embodiment of a wiper device in an assembly sequence,

FIGS. 6a to 6c show a perspective view of a further exemplary embodiment of a wiper device in an assembly sequence,

FIGS. 7a to 7c show a perspective view of a further exemplary embodiment of a wiper device in an assembly sequence,

FIGS. 8a to 8c show a perspective view of a further exemplary embodiment of a wiper device in an assembly sequence,

FIGS. 9a to 9c show a perspective view of a further exemplary embodiment of a wiper device in an assembly sequence,

FIGS. 10a to 10c show a perspective view of a further exemplary embodiment of a wiper device in an assembly sequence,

FIGS. 11a to 11c show a perspective view of a further exemplary embodiment of a wiper device in an assembly sequence,

FIGS. 12a to 12c show a perspective view of a further exemplary embodiment of a wiper device in an assembly sequence,

FIGS. 13a to 13c show a perspective view of a further exemplary embodiment of a wiper device in an assembly sequence,

FIGS. 14a and 14b show a perspective view of a further exemplary embodiment of a wiper device in an assembly sequence, and

FIGS. 15a and 15b show a perspective view of a further exemplary embodiment of a wiper device in an assembly sequence.

### DETAILED DESCRIPTION

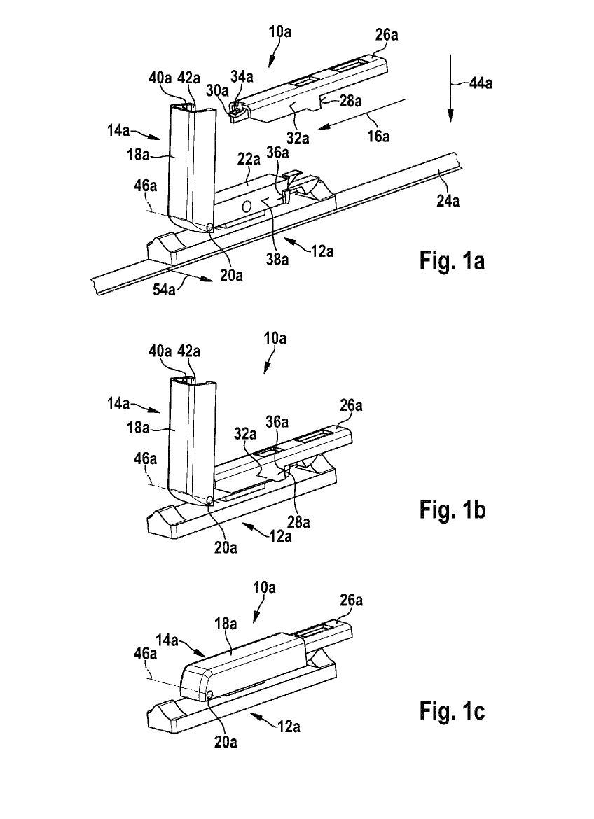

FIG. 1a shows a wiper device for a motor vehicle window, having a wiper arm adapter unit 10a and a wiper blade adapter unit 12a in an open state. On the wiper blade adapter unit 12a there is arranged a movably mounted locking means 14a which is formed by a hood element 18a.

The hood element 18a is pivotably mounted on a main body 22a of the wiper blade adapter unit 12a at a rotary joint 20a. The main body 22a connects the wiper blade adapter unit 12a to a separately formed wiper blade 24a. It is however also conceivable in this context for the wiper blade adapter unit 12a to be formed in one piece with the wiper blade 24a.

The wiper arm adapter unit 10a is formed in one piece with a wiper arm 26a. It is however also conceivable in this context for the wiper arm adapter unit 10a to be formed separately from the wiper arm 26a and for these to be connected to one another by means of a suitable connecting element.

The wiper arm adapter unit 10a has two back stops 28a and a fastening lug 30a. The back stops 28a terminate flush with side walls 32a of the wiper arm adapter unit 10a. The fastening lug 30a is formed as a projection on one end of the wiper arm adapter unit 10a and has a fastening recess 34a.

The main body 22a of the wiper blade adapter unit 12a has two integrally connected counterpart stops 36a which are arranged on side walls 38a of the main body 22a.

On two lateral inner surfaces 40a of the hood element 18a there are arranged two projections, formed in one piece with the inner surfaces 40a, as securing means 42a. The securing means 42a can be deflected out of an initial position and move back into the initial position automatically.

For assembly with the wiper blade adapter unit 12a, the wiper arm adapter unit 10a is lowered on to the main body 22a counter to a vertical direction 44a. Here, the back stops 28a terminate flush with the counterpart stops 36a and thus prevent a longitudinal movement, parallel to a longitudinal direction 16a, of the wiper arm adapter unit 10a relative to the wiper blade adapter unit 12a (FIG. 1b).

As is also shown in figure lb, the wiper arm adapter unit 10a rests in a positively engaging manner on the main body 22a. A movement relative to the main body 22a is possible only in a vertical direction 44a. To prevent said movement, the hood element 14a pivots by means of the rotary joint 20a about a pivot axis 46a arranged substantially in a transverse direction 54a, and surrounds the wiper arm adapter unit 10a in a positively engaging fashion.

The securing means 42a engage under the counterpart stops 36a and prevent a pivoting movement of the hood element 18a back into the open state. The wiper arm adapter unit 10a and the wiper blade adapter unit 12a are thus also secured in their vertical direction 44a and are situated in an assembled state (FIG. 1c). The hood element 14a forms a major part of a visible outer surface of the wiper blade adapter unit 12a.

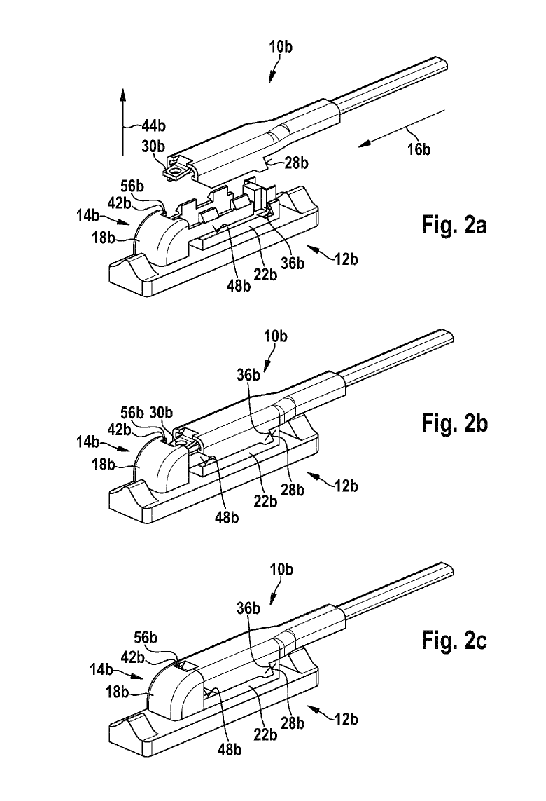

FIGS. 2 to 15 show fourteen further exemplary embodiments of the invention. The descriptions given below are restricted substantially to the differences between the exemplary embodiments, wherein with regard to consistent components, features and functions, reference may be made to the description of the first exemplary embodiment. For distinguishing between the exemplary embodiments, the letters a in the reference signs of the exemplary embodiment in FIG. 1 are replaced by the letters b to o in the reference signs of the exemplary embodiments of FIGS. 2 to 15. With regard to identically designated components, in particular with regard to components with the same reference signs, reference may basically also be made to the drawings and/or the description of the first exemplary embodiment.

FIG. 2a shows a second exemplary embodiment of a wiper device having a wiper arm adapter unit 10b and a wiper blade adapter unit 12b in an open state. The wiper arm adapter unit 10b corresponds to the wiper arm adapter unit 10a from the first exemplary embodiment.

The wiper blade adapter unit 12b has a main body 22b and a locking means 14b which is formed by a hood element 18b and which is mounted on the main body 22b so as to be displaceable along a longitudinal direction 16b.

The main body 22b has two counterpart stops 36b which prevent a movement of the wiper blade adapter unit 12b relative to the wiper arm adapter unit 10b along the longitudinal direction 16b in an assembled state. Furthermore, the main body 22b has a rest surface 48b for supporting the wiper arm adapter unit 10b.

FIG. 2b shows the wiper device in a second assembly step in which the wiper arm adapter unit 10b rests on the rest surface 48b of the wiper blade adapter unit 12b. Two back stops 28b of the wiper arm adapter unit 10b form a positive fit with the counterpart stops 36b of the wiper blade adapter unit 12b.

FIG. 2c shows the wiper device in an assembled state in which the hood element 18b is arranged over a fastening lug 30b of the wiper arm adapter unit 10b and thus a movement of the wiper arm adapter unit 10b relative to the wiper blade adapter unit 12b is prevented both in a longitudinal direction 16b and also in a vertical direction 44b.

To prevent a movement back into the open state, a securing means 42b is provided on the hood element 18b, said securing means being in the form of a detent means 56b and latching onto the fastening lug 30b. In this context, however, other securing means which would appear expedient to a person skilled in the art and which prevent an undesired movement of the hood element 18b back into the open state are also conceivable.

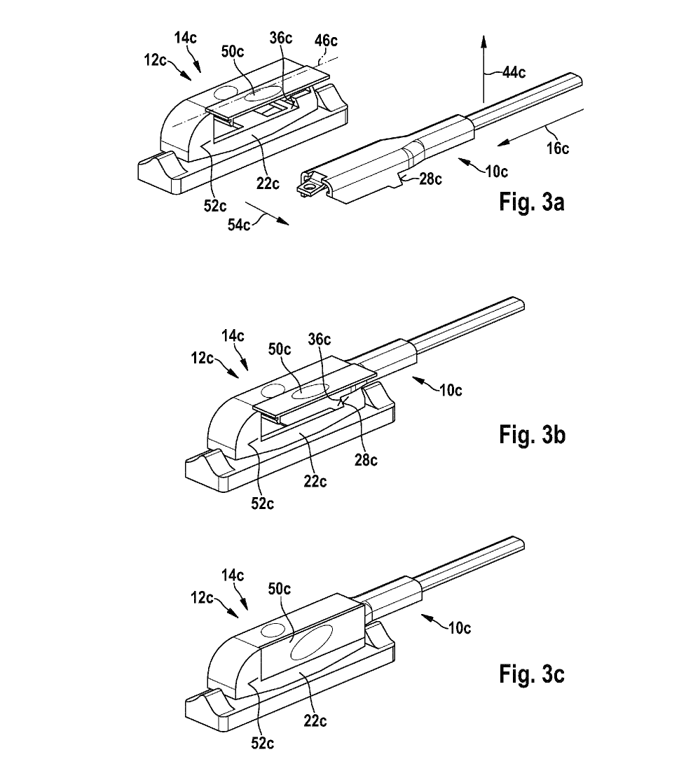

FIG. 3a shows a further exemplary embodiment of a wiper device having a wiper arm adapter unit 10c and a wiper blade adapter unit 12c in an open state. The wiper arm adapter unit 10c corresponds to the wiper arm adapter unit 10a from the first exemplary embodiment.

The wiper blade adapter unit 12c has a locking means 14c which is mounted so as to be pivotable about a pivot axis 46c and which is in the form of a cover flap 50c. The pivot axis 46c is arranged substantially parallel to a longitudinal direction 16c.

The wiper blade adapter unit 12c also has a main body 22c with an outer surface 52c. The outer surface 52c closes off the wiper blade adapter unit 12c to the outside, that is to say in the direction of a space surrounding the wiper device. A counterpart stop 36c is also arranged on the main body 22c.

The cover flap 50c is arranged laterally on the wiper blade adapter unit 12c and thus allows the wiper arm adapter unit 10c to be received in a linear movement running substantially parallel to a transverse direction 54c.

FIG. 3b shows a second assembly step in which the wiper arm adapter unit 10c has been pushed into the main body 22c. The outer surface 52c restricts the freedom of movement of the wiper arm adapter unit 10c relative to the wiper blade adapter unit 12c in a vertical direction 44c.

The counterpart stop 36c forms a positive fit with a back stop 28c of the wiper arm adapter unit 10c. A freedom of movement of the wiper arm adapter unit 10c is thus restricted in a longitudinal direction 16c. A movement of the wiper arm adapter unit 10c is possible only in a transverse direction 54c.

FIG. 3c shows the wiper device in an assembled state. The cover flap 50c is closed and terminates flush with an outer surface 52c of the wiper blade adapter unit 12c. In this way, the wiper arm adapter unit 10c is restricted in terms of its freedom of movement in the transverse direction 54c.

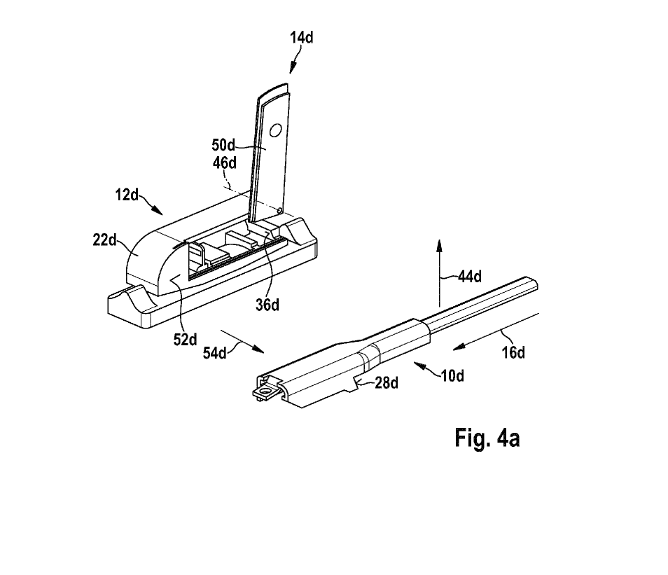

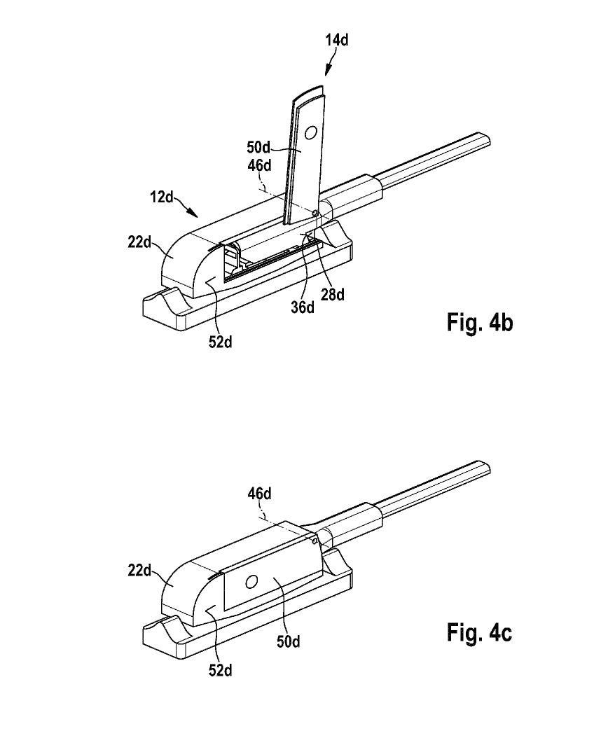

FIG. 4a shows a further exemplary embodiment of a wiper device having a wiper arm adapter unit 10d and a wiper blade adapter unit 12d in an open state. The wiper arm adapter unit 10d corresponds to the wiper arm adapter unit 10a from the first exemplary embodiment.

The wiper blade adapter unit 12d has a main body 22d with a locking means 14d which is in the form of a cover flap 50d. The cover flap 50d is mounted so as to be pivotable about a pivot axis 46d. The pivot axis 46d is arranged substantially parallel to a transverse direction 54d of the wiper arm adapter unit 10d.

The main body 22d has an outer surface 52d which substantially forms a termination of the wiper arm adapter unit 10d in an outward direction. Furthermore, a counterpart stop 36d is arranged on the main body 22d.

The cover flap 50d is arranged laterally on the wiper blade adapter unit 12d and thus allows the wiper arm adapter unit 10d to be received in a linear movement running substantially parallel to a transverse direction 54d.

FIG. 4b shows the wiper device in a second assembly step in which the wiper arm adapter unit 10d has been pushed into the main body 22d. The outer surface 52d restricts freedom of movement of the wiper arm adapter unit 10d in a vertical direction 44d.

The counterpart stop 36d forms a positive fit with a back stop 28d of the wiper arm adapter unit 10d. A freedom of movement of the wiper arm adapter unit 10d is thereby restricted in a longitudinal direction 16d. A movement of the wiper arm adapter unit 10d relative to the wiper blade adapter unit 12d is possible only in the transverse direction 54d.

FIG. 4c shows the wiper device in an assembled state. The cover flap 50d has been pivoted about the pivot axis 46d and terminates flush with an outer surface 52d of the wiper blade adapter unit 12d. The wiper arm adapter unit 10d is restricted in terms of its freedom of movement in the transverse direction 54d by the cover flap 50d.

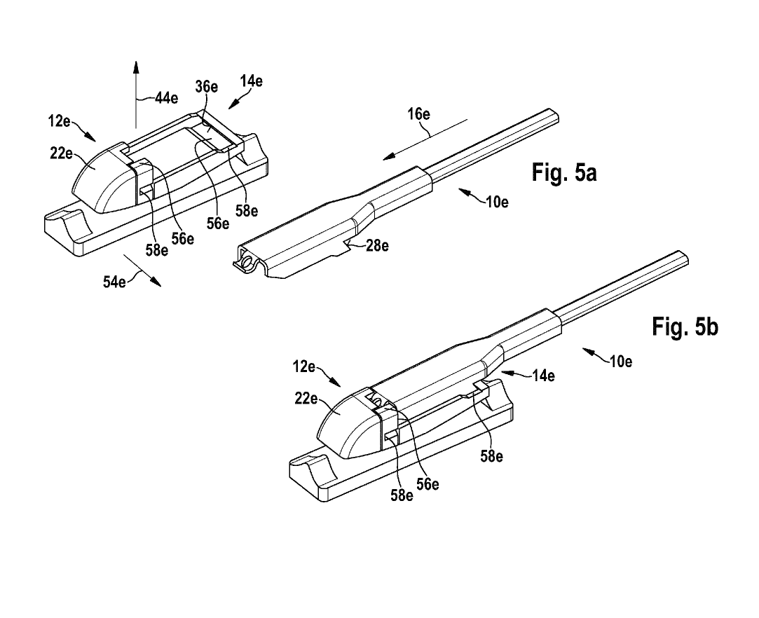

FIG. 5a shows a further exemplary embodiment of a wiper device having a wiper arm adapter unit 10e and a wiper blade adapter unit 12e in an open state. The wiper arm adapter unit 10e corresponds to the wiper arm adapter unit 10a from the first exemplary embodiment.

The wiper blade adapter unit 12e has a main body 22e with a locking means 14e. The locking means 14e has a first and a second flexible detent means 56e. The first and second detent means 56e is formed in each case in one piece with the main body 22e.

The first and second detent means 56e has in each case one detent lug 58e over which the wiper blade adapter unit 12e can be pushed. Here, the first and second detent means 56e is deflected counter to a deflection force in a vertical direction 44e. The main body 22e has a counterpart stop 36e which is arranged on a rear end of the wiper blade adapter unit 12e.

FIG. 5b shows the wiper device in an assembled state. The wiper arm adapter unit 10e has been pushed onto the main body 22e and forms a positive fit therewith. Back stops 28e of the wiper arm adapter unit 10e bear flush against the counterpart stop 36e of the wiper blade adapter unit 12e. In this way, the wiper arm adapter unit 10e is restricted in terms of its freedom of movement in a longitudinal direction 16e.

The first and second detent means 56e is situated, driven in each case by the deflection force, in its initial position and thus restricts the wiper arm adapter unit 10e in terms of its freedom of movement in a transverse direction 54e.

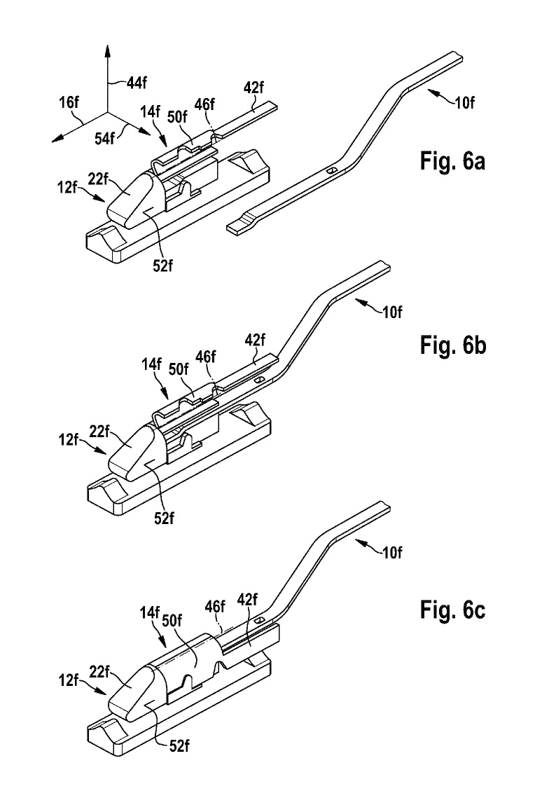

FIG. 6a shows a further exemplary embodiment of a wiper device having a wiper arm adapter unit 10f and a wiper blade adapter unit 12f in an open state.

The wiper blade adapter unit 12f has a main body 22f, with outer surfaces 52f and with a locking means 14f which is formed by a cover flap 50f which is mounted so as to be pivotable about a pivot axis 46f. The pivot axis 46f extends parallel to a longitudinal direction 16f.

FIG. 6b shows the wiper device in a second assembly step. The wiper arm adapter unit 10f has been pushed into the main body 22f of the wiper blade adapter unit 12f. The wiper arm adapter unit 10f is restricted in terms of its freedom of movement in a vertical direction 44f and in the longitudinal direction 16f by the outer surfaces 52f. A movement of the wiper arm adapter unit 10f is possible only in a transverse direction 54f.

FIG. 6c shows the wiper device in an assembled state. The cover flap 50f has been pivoted onto the main body 22f and terminates flush with the outer surfaces 52f. Securing means 42f arranged on the cover flap 50f latch onto the main body 22f and prevent the cover flap 50f from pivoting back into the open state.

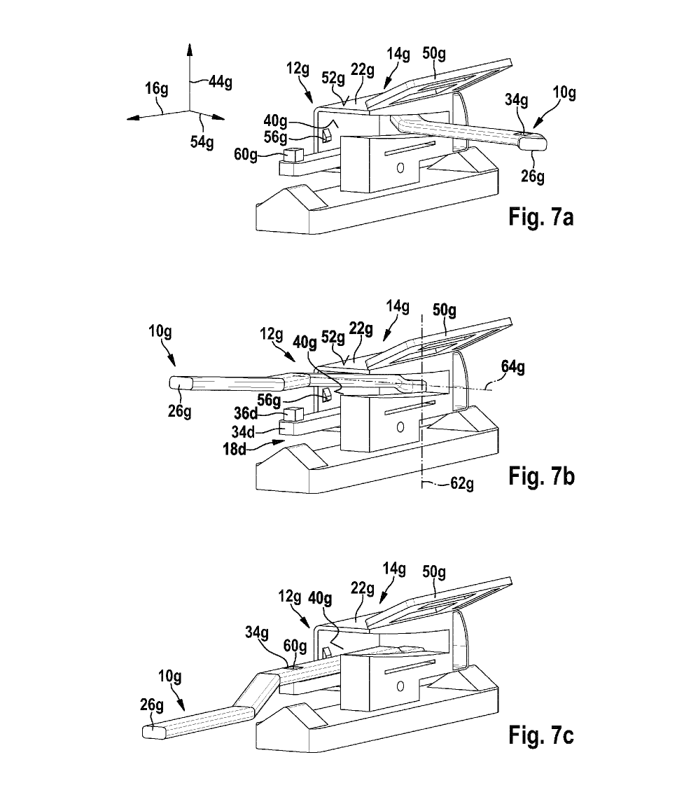

FIG. 7a shows a further exemplary embodiment of a wiper device having a wiper arm adapter unit 10g and a wiper blade adapter unit 12g in an open state. The wiper arm adapter unit 10g has a wiper arm 26g with a fastening recess 34g.

The wiper blade adapter unit 12g has a main body 22g with a locking means 14g. The locking means 14g is formed by a detent means 56g which is formed in one piece with the main body 22g. The main body 22g also has a cover flap 50g and a fastening pin 60g. The wiper arm adapter unit 10g bears with an outer end against an inner surface 40g of the main body 22g of the wiper blade adapter unit 12g.

FIG. 7b shows the wiper device in a second assembly step. The wiper arm adapter unit 10g has been rotated about a vertical axis 62g which is arranged parallel to a vertical direction 44g. The outer end of the wiper arm adapter unit 10g is thus restricted in terms of its freedom of movement in the vertical direction 44g and also in a transverse direction 54g.

FIG. 7c shows the wiper device in a third assembly step. The wiper arm adapter unit 10g has been rotated about a transverse axis 64g which runs parallel to the transverse direction 54g. The fastening recess 34g of the wiper arm 26g terminates flush with the fastening pin 60g. The fastening pin 60g thereby prevents a movement of the wiper arm adapter unit 10g in a longitudinal direction 16g.

During assembly, the detent means 56g is deflected by the wiper arm adapter unit 10g out of an initial position counter to a deflection force. In the third assembly step, the detent means 56g is situated in the initial position again after a deflection. In an assembled state, the cover flap 50g terminates flush with an outer surface 52g of the main body 22g.

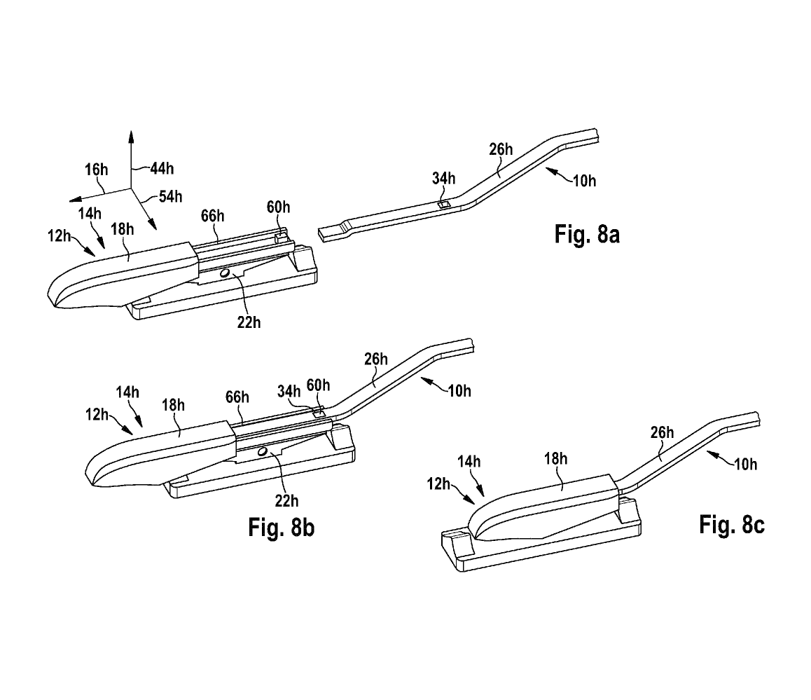

FIG. 8a shows a further exemplary embodiment of a wiper device having a wiper arm adapter unit 10h and a wiper blade adapter unit 12h in an open state. The wiper arm adapter unit 10h has a fastening recess 34h in a wiper arm 26h.

The wiper blade adapter unit 12h has a locking means 14h which is mounted so as to be linearly displaceable. The locking means 14h is formed by a hood element 18h. The hood element 18h can be displaced along a guide rail 66h of a main body 22h of the wiper blade adapter unit 12h parallel to a longitudinal direction 16h.

FIG. 8b shows the wiper device in a second assembly step. The wiper arm adapter unit 10h is arranged in the guide rail 66h. The fastening recess 34h terminates flush with a fastening pin 60h and thereby restricts the wiper arm adapter unit 10h in terms of its freedom of movement in the longitudinal direction 16h.

The guide rail 66h prevents a movement of the wiper arm adapter unit 10h in a transverse direction 54h. A movement of the wiper arm adapter unit 10h is possible only in a vertical direction 44h. To prevent the movement of the wiper arm adapter unit 10h in a vertical direction 44h, the hood element 18h is pushed along the guide rail 66h.

FIG. 8c shows the wiper device in an assembled state. The hood element 18h forms a major part of a visible outer surface of the wiper blade adapter unit 12h. To prevent the hood element 18h from sliding back in an undesired manner, the hood element 18h has detent elements (not illustrated) on an inner surface.

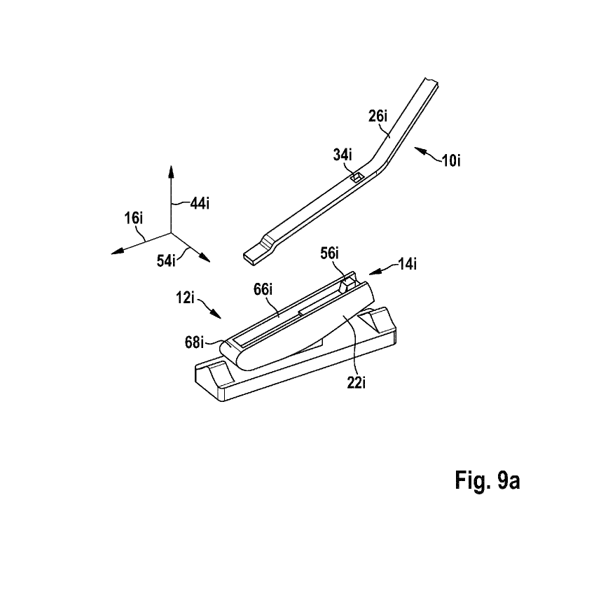

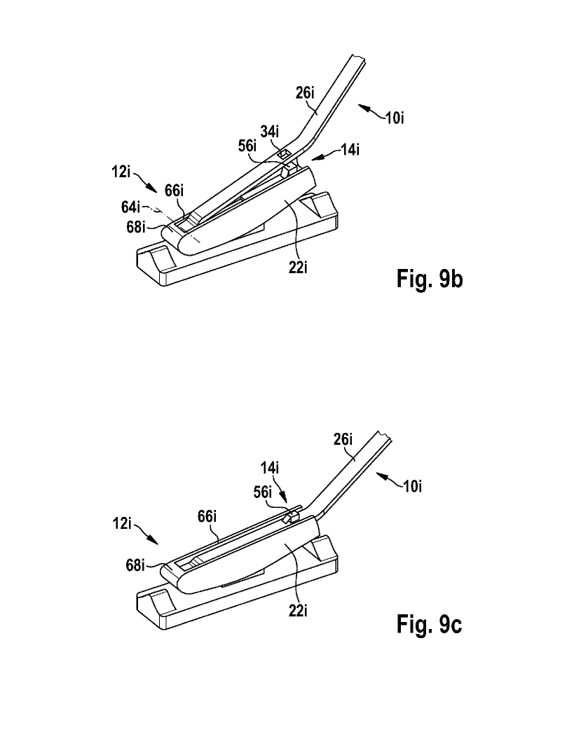

FIG. 9a shows a further exemplary embodiment of a wiper device having a wiper arm adapter unit 10i and a wiper blade adapter unit 12i in an open state. The wiper arm adapter unit 10i has a fastening recess 34i arranged in a wiper arm 26i.

The wiper blade adapter unit 12i has a main body 22i with a guide rail 66i and with a locking means 14i. The locking means 14i is in the form of a detent means 56i which is integrally connected to the main body 22i. A projection 68i is arranged on one end of the guide rail 66i.

FIG. 9b shows the wiper device in a second assembly step. One end of the wiper arm adapter unit 10i has been inserted under the projection 68i. A rotation of the wiper arm adapter unit 10i about a transverse axis 64i brings the wiper device into an assembled state (FIG. 9c). Here, the detent means 56i is initially deflected by the wiper arm adapter unit 10i and subsequently latches into the fastening recess 34i.

In the assembled state, the wiper arm adapter unit 10i is restricted in terms of its freedom of movement in a transverse direction 54i. The detent means 56i restricts the wiper arm adapter unit 10i in a longitudinal direction 16i and in a vertical direction 44i.

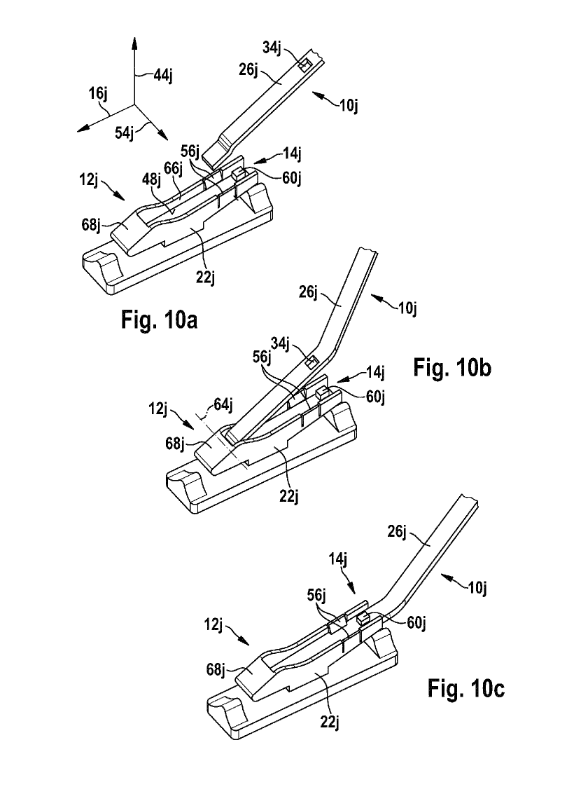

FIG. 10a shows a further exemplary embodiment of a wiper device having a wiper arm adapter unit 10j and a wiper blade adapter unit 12j in an open state. The wiper arm adapter unit 10j has a fastening recess 34j arranged in a wiper arm 26j.

The wiper blade adapter unit 12j has a main body 22j with a guide rail 66j and with a locking means 14j. The locking means 14j is in the form of a detent means 56j which is integrally connected to the guide rails 66j. A projection 68j is arranged on one end of the guide rail 66j.

FIG. 10b shows the wiper device in a second assembly step. One end of the wiper arm adapter unit 10j has been inserted under the projection 68j. A rotation of the wiper arm adapter unit 10j about a transverse axis 64j brings the wiper device into an assembled state (FIG. 10c). Here, the detent means 56j is initially deflected by the wiper arm adapter unit 10j in a transverse direction 54j and subsequently latches over the wiper arm 26j. The fastening recess 34j terminates flush with a fastening pin 60j which is arranged on a rest surface 48j of the main body 22j.

In the assembled state, the wiper arm adapter unit 10j is restricted in terms of its freedom of movement in a transverse direction 54j. The detent means 56j restricts the wiper arm adapter unit 10j only in a vertical direction 44j. A movement of the wiper arm adapter unit 10j in the longitudinal direction 16j is prevented by a positive fit between the fastening recess 34j and the fastening pin 60j.

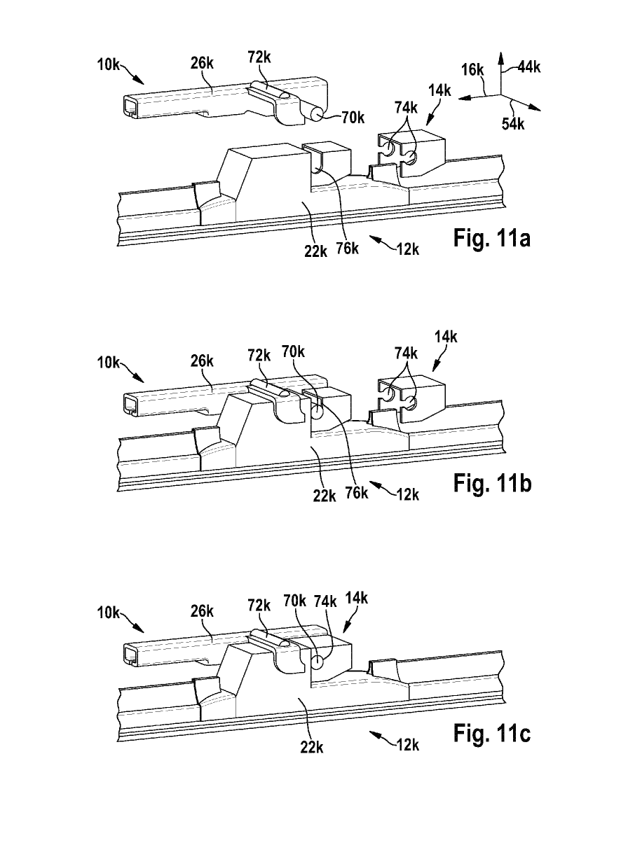

FIG. 11a shows a further exemplary embodiment of a wiper device having a wiper arm adapter unit 10k and a wiper blade adapter unit 12k in an open state.

The wiper arm adapter unit 10k has a fastening element 70k and a support plate 72k. The fastening element 70k extends in the manner of a cylinder in a transverse direction 54k of the wiper arm adapter unit 10k. The support plate 72k extends initially in the transverse direction 54k and then bends away counter to a vertical direction 44k.

The wiper blade adapter unit 12k has a freely movable locking means 14k with a substantially U-shaped profile, and two substantially C-shaped detent recesses 74k.

FIG. 11b shows the wiper device in a second assembly step. The support plate 72k of the wiper arm adapter unit 10k rests on a main body 22k of the wiper blade adapter unit 12k. The fastening element 70k is arranged in a positively engaging manner in a depression 76k, which extends in the vertical direction 44k, of the main body 22k.

A freedom of movement of the wiper arm adapter unit 10k is restricted in a longitudinal direction 16k. In the transverse direction 54k, the freedom of movement of the wiper arm adapter unit 10k relative to the wiper blade adapter unit 12k is restricted by the bent support plate 72k and by a wiper arm 26k which is connected to the wiper arm adapter unit 10k.

FIG. 11c shows the wiper device in an assembled state. The locking means 14k has been pushed over the main body 22k and engages into the latter, such that a movement in the vertical direction 44k is prevented. The detent recesses 74k engage around the fastening element 70k and form a detent connection therewith. In this way, the locking means 14k restricts the wiper arm adapter unit 10k in terms of its freedom of movement in the vertical direction 44k.

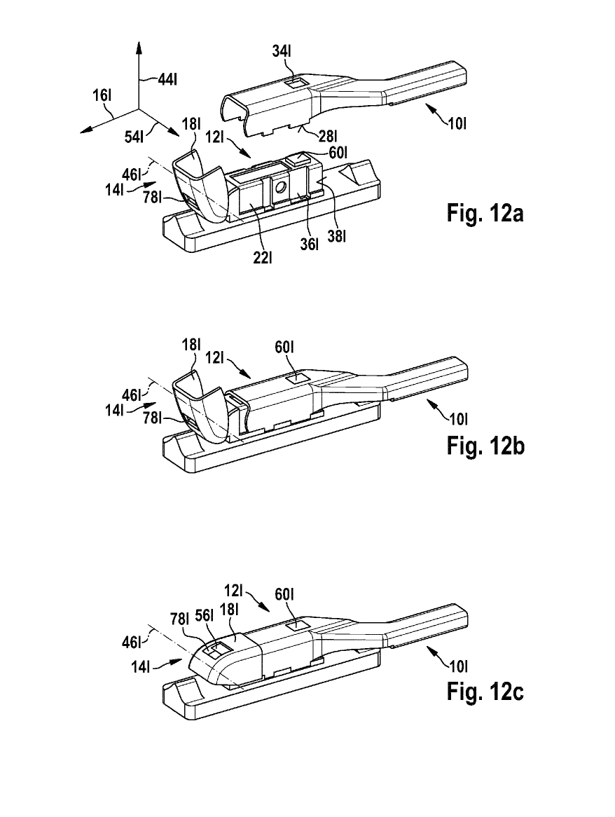

FIG. 12a shows a further exemplary embodiment of a wiper device having a wiper arm adapter unit 101 and a wiper blade adapter unit 121 in an open state. The wiper arm adapter unit 101 has a fastening recess 341 and a back stop 281.

The wiper blade adapter unit 121 has a locking means 141 which is mounted so as to be pivotable about a pivot axis 461 and which is formed by a hood element 181. The pivot axis 461 is arranged parallel to a transverse direction 541.

The wiper blade adapter unit 121 furthermore has a main body 221 with a fastening pin 601 which has a substantially square cross section. A counterpart stop 361 is arranged on the main body 221 on a side wall 381.

FIG. 12b shows the wiper device in a second assembly step. The wiper arm adapter unit 101 rests on the main body 221 of the wiper blade adapter unit 121. The fastening recess 341 forms a positive fit with the fastening pin 601 and thereby prevents the movement of the wiper arm adapter unit 101 in a longitudinal direction 161 and in the transverse direction 541. Furthermore, the freedom of movement in the longitudinal direction 161 is prevented by a positive fit between the counterpart stop 361 and the back stop 281.

To prevent a movement of the wiper arm adapter unit 101 in a vertical direction 441, the locking means 141 is pivoted about the pivot axis 461. Here, a part of the hood element 181 engages over the wiper blade adapter unit 121 and restricts the wiper arm adapter unit 101 in terms of its freedom of movement relative to the wiper blade adapter unit 121 in the vertical direction 441.

FIG. 12c shows the wiper device in an assembled state. The hood element 181 is prevented from pivoting back into the open state by a detent means 561 which is arranged in a recess 781 of the hood element 181. The detent means 561 latches with the main body 221 in a manner familiar to a person skilled in the art.

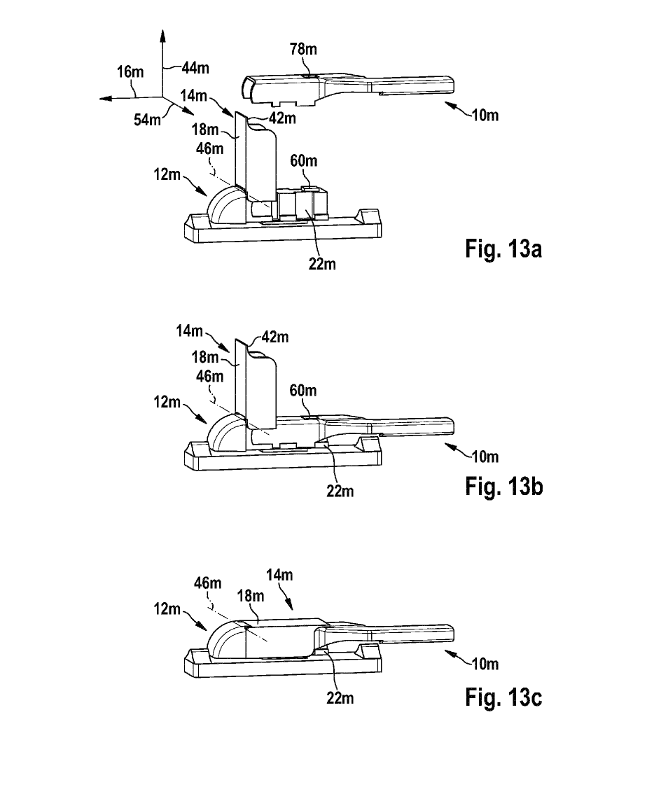

FIG. 13a shows a further exemplary embodiment of the wiper device from FIGS. 12a-c having a locking means 14m which is in the form of a hood element 18m and which is arranged so as to be pivotably mounted on the wiper blade adapter unit 12m. The hood element 18m has a securing means 42m in the form of a pin.

FIG. 13b shows the wiper device in a second assembly step. The hood element 18m forms a lateral guide for the wiper arm adapter unit 10m.

FIG. 13c shows the wiper device in an assembled state. The hood element 18m has been pivoted onto the wiper arm adapter unit 10m and forms a positive fit with the latter. The securing means 42m latches into a recess 78m of a main body 22m of the wiper blade adapter unit 12m. The recess 78m is arranged in a fastening pin 60m of the main body 22m. The hood element 18m is thus prevented from pivoting back into the open state.

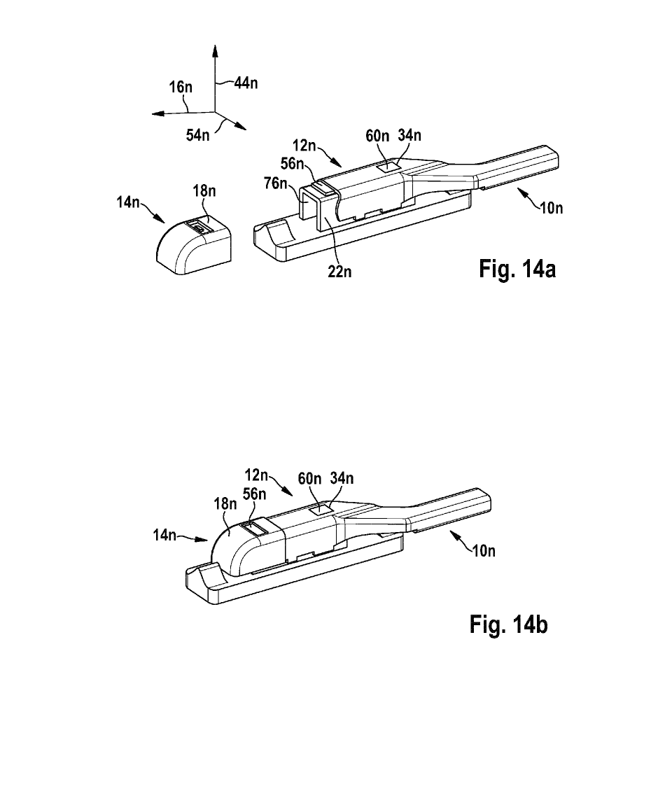

FIG. 14a shows a further exemplary embodiment of a wiper device having a wiper arm adapter unit 10n and a wiper blade adapter unit 12n in an open state. The wiper arm adapter unit 10n has a fastening recess 34n.

The wiper blade adapter unit 12n has a locking means 14n which is mounted so as to be freely movable and which is formed by a hood element 18n. The wiper blade adapter unit 12n furthermore has a main body 22n with a fastening pin 60n which has a substantially square cross section.

The fastening recess 34n forms a positive fit with the fastening pin 60n and thus prevents a movement of the wiper arm adapter unit 10n in a longitudinal direction 16n and in a transverse direction 54n. A movement of the wiper arm adapter unit 10n is possible only in a vertical direction 44n.

FIG. 14b shows the wiper device in an assembled state. The hood element 18n has been pushed over the wiper arm adapter unit 10n and latched into two depressions 76n arranged in the main body 22n. The hood element 18n is prevented from sliding back by a detent means 56n which is arranged on the main body 22n. The detent means 56n engages into a recess of the hood element 18n.

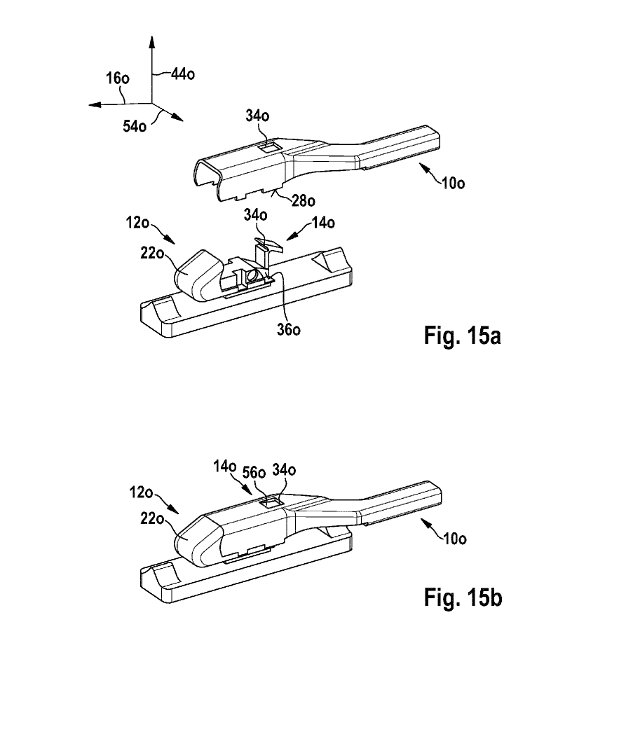

FIG. 15a shows a further exemplary embodiment of a wiper device having a wiper arm adapter unit 10o and having a wiper blade adapter unit 12o in an open state. The wiper arm adapter unit 10o has a fastening recess 34o and a back stop 280.

The wiper blade adapter unit 12o has a main body 22o with a locking means 14o. The locking means 14o is in the form of a detent means 56o which is integrally connected to the main body 22o. The main body 22o has a counterpart stop 36o.

FIG. 15b shows the wiper device in an assembled state. The wiper arm adapter unit 10o forms a positive fit with the main body 22o. A movement of the wiper arm adapter unit 10o in a transverse direction 54o is thereby prevented. The counterpart stop 36o of the main body 22o terminates flush with the back stop 28o of the wiper arm adapter unit 10o and thereby prevents a movement of the wiper arm adapter unit 10o relative to the wiper blade adapter unit 12o in a longitudinal direction 16o.

The detent means 56o latches into the fastening recess 34o of the wiper arm adapter unit 10o. A freedom of movement of the wiper arm adapter unit 10o in a vertical direction 44o is thereby restricted.

1. A wiper device for a motor vehicle window, having a wiper arm adapter unit (10a-10o) and having a wiper blade adapter unit (12a-12o) which form a positive fit in an assembled state, characterized by at least one locking means (14a-14o) which is mounted in a movable manner on the wiper blade adapter unit (12a-12o), said locking means restricting freedom of movement of the wiper arm adapter unit (10a-10o) in a direction differing from a longitudinal direction (16a-16o) in the assembled state.

2. The wiper device as claimed in claim 1, characterized in that the locking means (14a; 14c; 14d; 14f; 14l; 14m) is mounted so as to be pivotable relative to a main body (22a; 22c; 22d; 22f; 22l; 22m) of the wiper blade adapter unit (12a; 12c; 12d; 12f; 12l; 12m) about a pivot axis (46a; 46c; 46d; 46f; 46l; 46m).

3. The wiper device at least as claimed in claim 2, characterized in that the pivot axis (46c; 46f) is arranged at least substantially parallel to a longitudinal direction (16c; 16f) of the wiper arm adapter unit (10c; 10f).

4. The wiper device at least as claimed in claim 2, characterized in that the pivot axis (46a; 46d; 46l; 46m) is arranged at least substantially parallel to a transverse direction (16a; 16d; 16l; 16m) of the wiper arm adapter unit (10a; 10d; 10l; 10m).

5. The wiper device as claimed in claim 1, characterized in that the locking means (14b; 14h; 14k; 14n) is mounted so as to be linearly displaceable relative to a main body (22b; 22h; 22k; 22n) of the wiper blade adapter unit (12b; 12h; 12k; 12n).

6. The wiper device as claimed in claim 1, characterized by at least one securing means (42a; 42b; 42m) which prevents a movement of the locking means (14a; 14b; 14m) relative to a main body (22a; 22b; 22m) of the wiper blade adapter unit (12a; 12b; 12m) in at least one operating state.

7. The wiper device as claimed in claim 1, characterized in that, in at least one operating state, the locking means (14a; 14f; 14h; 14m) forms at least a major part of a visible outer surface of the wiper blade adapter unit (12a; 12f; 12h; 12m).

8. The wiper device as claimed in claim 1, characterized in that the locking means (14e; 14g; 14i; 14j; 14o) is in the form of detent means (56e; 56g; 56i; 56j; 56o).

9. The wiper device as claimed in claim 8, characterized in that the detent means (56e; 56g; 56i; 56n; 56o) is formed in one piece with a main body (22e; 22g; 22i; 22n; 22o) of the wiper arm adapter unit (10e; 10g; 10i; 10n; 10o).

10. A wiper blade adapter unit of a wiper device as claimed in claim 1.

11. A wiper blade having a wiper blade adapter unit as claimed in claim 10.
